(19) United States
(12) Patent Application Publication
(10) Pub. No.: US 2024/0381118 A1
(43) Pub. Date: Nov. 14, 2024

(54) OVER-THE-AIR (OTA) DATA AGGREGATION

(71) Applicant: QUALCOMM Incorporated, San Diego, CA (US)

(72) Inventors: Hamed PEZESHKI, San Diego, CA (US); Tao LUO, San Diego, CA (US); Taesang YOO, San Diego, CA (US); Eren BALEVI, Brooklyn, NY (US); Srinivas YERRAMALLI, San Diego, CA (US); Junyi LI, Greentown, PA (US)

(21) Appl. No.: 18/696,277

(22) PCT Filed: Oct. 19, 2022
(86) PCT No.: PCT/US2022/078333

§ 371 Date: Mar. 27, 2024

(30) Foreign Application Priority Data
Nov. 22, 2021 (IN) 202141053699

(51) Int. Cl. H04W 16/28; H04L 5/00; H04W 24/02

(52) U.S. Cl. CPC H04W 16/28; H04L 5/0051; H04W 24/02

(57) ABSTRACT

Certain aspects of the present disclosure provide techniques for over-the-air (OTA) aggregation of data. Certain techniques include transmitting, to a plurality of user equipments (UEs), a first reference signal (RS) via a first transmit beam of a base station (BS), wherein the plurality of UEs and the BS share a global federated learning model: receiving, in response to the first RS, a first set of signals each carrying corresponding local gradient information of a first set of local gradient information for the global federated learning model, the first set of local gradient information comprising local gradient information calculated by each UE of multiple UEs of the plurality of UEs, the first set of local gradient information received via a first receive beam of the BS; and aggregating, in an analog domain, the first set of signals to aggregate the first set of local gradient information received from the multiple UEs.

### RELATED APPLICATIONS

This application claims benefit of and priority to India Patent Application Serial No. 202141053699, filed Nov. 22, 2021, hereinafter incorporated by reference in its entirety as if fully set forth below and for all applicable purposes.

### INTRODUCTION

Aspects of the present disclosure relate to wireless communications, and more particularly, to techniques for aggregating data over an air interface.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect provides a base station (BS) configured for wireless communication, comprising: a memory; and a processor coupled to the memory. The processor and the memory configured to cause the BS to: transmit, to a plurality of UEs, a first reference signal (RS) via a first transmit beam of the BS, wherein the plurality of UEs and the BS share a global federated learning model; receive, in response to the first RS, a first set of signals each carrying corresponding local gradient information of a first set of local gradient information for the global federated learning model, the first set of local gradient information comprising local gradient information calculated by each UE of multiple UEs (meaning two or more UEs) of the plurality of UEs, the first set of local gradient information received via a first receive beam of the BS; and aggregate, in an analog domain, the first set of signals to aggregate the first set of local gradient information received from the multiple UEs.

One aspect provides a user equipment (UE) configured for wireless communication, comprising: a memory; and a processor coupled to the memory. The processor and the memory configured to cause the UE to: receive, from a base station (BS), a first reference signal (RS); receive, from the BS, a second RS; transmit, to the BS, local gradient information at a first transmit power based on both a first power control loop and received power of the first RS at the UE, wherein the local gradient information is for a federated learning model shared by the UE and the BS; and transmit, to the BS, data at a second transmit power based on both a second power control loop and received power of the second RS at the UE.

One aspect provides a method of wireless communication by a BS. The method includes: transmitting, to a plurality of UEs, a first reference signal (RS) via a first transmit beam of the BS, wherein the plurality of UEs and the BS share a global federated learning model; receiving, in response to the first RS, a first set of signals each carrying corresponding local gradient information of a first set of local gradient information for the global federated learning model, the first set of local gradient information comprising local gradient information calculated by each UE of multiple UEs of the plurality of UEs, the first set of local gradient information received via a first receive beam of the BS; and aggregating, in an analog domain, the first set of signals to aggregate the first set of local gradient information received from the multiple UEs.

One aspect provides a method of wireless communication by a UE. The method includes: receiving, from a base station (BS), a first reference signal (RS); receiving, from the BS, a second RS; transmitting, to the BS, local gradient information at a first transmit power based on both a first power control loop and received power of the first RS at the UE, wherein the local gradient information is for a federated learning model shared by the UE and the BS; and transmitting, to the BS, data at a second transmit power based on both a second power control loop and received power of the second RS at the UE.

One aspect provides a BS. The BS includes: means for transmitting, to a plurality of UEs, a first reference signal (RS) via a first transmit beam of the BS, wherein the plurality of UEs and the BS share a global federated learning model; means for receiving, in response to the first RS, a first set of signals each carrying corresponding local gradient information of a first set of local gradient information for the global federated learning model, the first set of local gradient information comprising local gradient information calculated by each UE of multiple UEs of the plurality of UEs, the first set of local gradient information received via a first receive beam of the BS; and means for aggregating, in an analog domain, the first set of signals to aggregate the first set of local gradient information received from the multiple UEs.

One aspect provides a UE. The UE includes: means for receiving, from a base station (BS), a first reference signal (RS); means for receiving, from the BS, a second RS; means for transmitting, to the BS, local gradient information at a first transmit power based on both a first power control loop and received power of the first RS at the UE, wherein the local gradient information is for a federated learning model shared by the UE and the BS; and means for transmitting, to the BS, data at a second transmit power based on both a second power control loop and received power of the second RS at the UE.

One aspect provides a non-transitory computer readable medium storing instructions, that when executed by a BS, cause the BS to perform operations. The operations include: transmitting, to a plurality of UEs, a first reference signal (RS) via a first transmit beam of the BS, wherein the plurality of UEs and the BS share a global federated learning model; receiving, in response to the first RS, a first set of signals each carrying corresponding local gradient information of a first set of local gradient information for the global federated learning model, the first set of local gradient information comprising local gradient information calculated by each UE of multiple UEs of the plurality of UEs, the first set of local gradient information received via a first receive beam of the BS; and aggregating, in an analog domain, the first set of signals to aggregate the first set of local gradient information received from the multiple UEs.

One aspect provides a non-transitory computer readable medium storing instructions, that when executed by a UE, cause the UE to perform operations. The operations include: receiving, from a base station (BS), a first reference signal (RS); receiving, from the BS, a second RS; transmitting, to the BS, local gradient information at a first transmit power based on both a first power control loop and received power of the first RS at the UE, wherein the local gradient information is for a federated learning model shared by the UE and the BS; and transmitting, to the BS, data at a second transmit power based on both a second power control loop and received power of the second RS at the UE.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example of a base station and user equipment.

FIGS. 3A-3D depict various example aspects of data structures for a wireless communication network.

FIG. 4 is a schematic diagram illustrating an example of a federated learning architecture.

FIG. 5 is a call-flow diagram illustrating example communications between a base station (BS) and both of a first user equipment (UE) and a second UE.

FIG. 6 is a flow diagram illustrating example operations for wireless communication, in accordance with certain aspects of the present disclosure

FIG. 7 is a flow diagram illustrating example operations for wireless communication, in accordance with certain aspects of the present disclosure

FIG. 8 depicts aspects of an example communications device.

FIG. 9 depicts aspects of an example communications device.

### DETAILED DESCRIPTION

Aspects of the present disclosure provide apparatuses, methods, processing systems, and computer-readable mediums for over-the-air (OTA) aggregation of data, such as gradient data for a federated learning model. Though certain aspects are discussed herein with respect to OTA aggregation of gradient data, it should be understood that the techniques herein may similarly be applied to aggregation of other suitable types of data.

Federated learning is a decentralized form of machine learning, where one or more local clients (e.g., user equipment (UEs)) collaboratively train a statistical model under the orchestration of a central device (e.g., server, serving cell, base station (BS), etc.) while keeping the training data decentralized. That is, machine learning algorithms, such as deep neural networks, are trained on raw data collected from multiple local datasets contained in the UEs.

In some examples, machine learning relies on the aggregation of the raw data at a centralized data center (e.g., Cloud) for training. However, collection of the data may violate the laws on user privacy and data confidentiality. With federated learning, the raw data may remain on the UEs, thereby improving data privacy for all users.

For example, in federated learning, each of one or more UEs may provide a BS with an updated gradient (e.g., a vector which gives the direction of maximum rate of change) based on data local to each of the UEs. Thus, instead of providing local data to the BS, each of the one or more UEs calculates its own local gradient updates based on data local to that UE. Each of the UEs may then send the corresponding local gradient updates to the BS, so that the BS may train the shared statistical model using the received local gradient updates.

In some examples, the BS may first calculate an average of the received local gradient updates, then update the shared statistical model using the calculated average. However, in order to calculate the average, the BS may need to know how many UEs will be providing it with local gradient updates. Further, the BS may need to decode each of the received local gradients in the digital domain and compute the average in the digital domain, thus using significant compute resources. Thus, techniques for managing transmission and reception of local gradient updates could help increase efficiency of communications and statistical model updates.

In particular, certain aspects herein are directed to using the principles of superposition to combine the received local gradients from a plurality of UEs in the analog domain at the BS and compute the average, thereby reducing the use of compute resources at the BS. However, to use the principles of superposition, the signals from the plurality of UEs carrying the received local gradient updates may need to be synchronized in the power at which they are received at the BS, and the timing at which they are received at the BS.

Certain aspects herein provide techniques related to synchronizing the power at which the local gradient updates are received at the BS. Certain aspects herein further provide mechanisms for grouping UEs to participate in a federated learning OTA aggregation, such as mechanisms to group together UEs that are able to transmit at a transmit power such that the power at which the local gradient updates are received at the BS from the UEs in the group is within a threshold range. For example, the UEs may be grouped based on being in a similar location, therefore the signals can be received using a same receive beam of the BS to perform the aggregation in the analog domain.

Certain aspects herein provide techniques related to synchronizing the timing at which the local gradient updates are received at the BS. Certain aspects further group together UEs such that the timing at which the local gradient updates are received at the BS from the UEs in the group is within a threshold range. For example, the UEs may be grouped based on being in a similar location, thereby having similar path delays. Accordingly, techniques herein help synchronize power and timing at which signals are received at the BS from the UE to allow for aggregation of data in the analog domain, thereby saving compute resources at the BS.

In certain aspects, the disclosure is directed to the BS grouping a plurality of UEs for participation in OTA aggregation. In certain aspects, the BS groups the plurality of UEs together based on a location of the UEs, such that the group of UEs are within a particular geographical area, or within a threshold distance from a particular location.

The BS may then transmit a reference signal (RS) (e.g., a downlink (DL) RS such as a channel state information (CSI)-RS or a demodulation RS (DMRS)) to the group of UEs using a transmit beam of the BS. The transmit beam, in certain aspects, may be in the general direction of the group of UEs. The transmit beam used for OTA aggregation may be a wider beam than used for other purposes, such as for channel estimation for data. The RS may be specific for the transmit beam used for OTA aggregation. For example, a different RS on a narrower transmit beam may be used for data, such that the UE uses one power control loop based on the RS for the transmit beam used for OTA, and a different power control loop based on the RS for the transmit beam for data. The power control loops may be used for the UE to perform uplink power control to determine a transmit power to use for transmitting on an uplink, such as to the BS. Thus, the UE may perform uplink power control separately for OTA aggregation related communication and data communications (e.g., on a physical uplink shared channel, physical uplink control channel, etc.).

Each of the UEs of the group may use the RS to estimate channel conditions between the BS and the UE. For example, the UEs may measure a received power of the RS, and utilize the measurements as part of a power control loop used to control transmit power used by the UE to transmit a local gradient update. In particular, the BS may have indicated spatial relation information to the UE, which may refer to a relationship between the DL RS transmitted by the BS, and an uplink RS and/or transmission of the local gradient update by the UE to the BS. The indication of spatial relation configures the UE to transmit an UL RS and/or local gradient update in the opposite (e.g., reciprocal) direction from which it received the DL RS previously. More specifically, the UE applies Tx spatial filtering configuration for the transmission of the UL RS and/or local gradient update that is based on the Rx spatial filtering configuration (e.g., is the same as, substantially same as, etc.) the UE used to receive the DL RS previously. In certain aspects, the BS may form multiple groups of UEs, each group associated with a different transmit/receive beam of the BS, meaning a different transmit beam is used to transmit a different RS to each group, and a corresponding different receive beam is used to receive the local gradient updates for each group. By using the same transmit and receive beam to receive the local gradient update from each UE in the group, and by the UEs in the group performing power control based on the same RS, the local gradient updates may be received at power levels within a threshold range at the BS.

Where multiple receive beams are used by the BS, such as in a spatial division multiplexing (SDM) manner, to receive local gradient updates from different groups, the local gradient updates of each group may be aggregated in the analog domain, while the aggregated local gradient updates of different groups may be summed in the digital domain.

In certain aspects, the UEs in a group are in a similar location and therefore have a similar delay or round-trip-time between the UE and the BS. Accordingly, transmissions from the UEs in the group, if transmitted by each UE at similar times, are likely to arrive at the BS at similar times. Accordingly, in certain aspects, the UEs in the group are configured to use the RS as a trigger for transmitting the local gradient update, such as at a certain time after receiving the RS. Thus, the local gradient updates may be synchronized in timing when received at the BS.

In some aspects, a particular UE in a group may not be able to participate in a round of federated learning, such as by not being able to meet power requirements or timing requirements for transmission of the local gradient update, such as due to interference, maximum permissible exposure (MPE) issues, etc. Accordingly, the UE may inform the BS so the BS can account for the number of UEs over which to average the local gradient updates in the group.

In certain aspects, the disclosure is directed to transmitting, by a BS, a first signal (e.g., reference signal (RS)) to multiple UEs, wherein the first signal is configured to trigger the multiple UEs to respond by transmitting local gradient updates to the BS. Thus, the multiple UEs may receive the first signal at substantially the same time, thereby ensuring that the updates transmitted by the multiple UEs are time aligned (e.g., each of the multiple UEs transmit their respective updates simultaneously, or within a permissible window of time after receiving the signal).

In certain aspects, the BS may selectively group multiple UEs based on a location of the UE and/or a direction of the UE relative to the BS. For example, the BS may group multiple UEs based on each of the multiple UEs having a same direction (e.g., west) from the perspective of the BS, and/or each of the multiple UEs being within a particular distance of the BS. In such an example, the BS may transmit the first signal using a broad beam so that each of the multiple UEs of the group may receive the first signal. The broad beam may be relatively broader than a beam directed to a particular one of the multiple UEs, and may be used for multicasting. The BS may selectively form one or more groups of UEs to support communication with UEs in different directions relative to the BS.

Thus, communication of gradient updates to a statistical model may be provided more efficiently.

### Introduction to Wireless Communication Networks

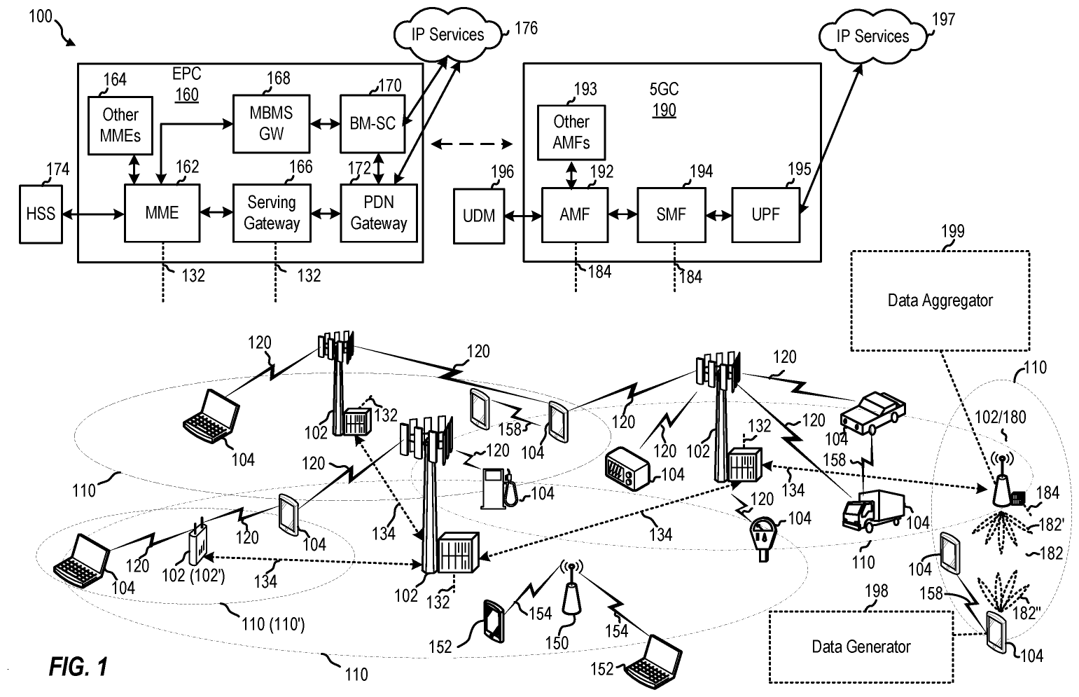

FIG. 1 depicts an example of a wireless communications system 100, in which aspects described herein may be implemented.

Generally, wireless communications system 100 includes base stations (BSs) 102, user equipments (UEs) 104, one or more core networks, such as an Evolved Packet Core (EPC) 160 and 5G Core (5GC) network 190, which interoperate to provide wireless communications services.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

Wireless communication network 100 includes a data aggregator 199, which may be configured to aggregate data received from a plurality of UEs. Wireless network 100 further includes a data generator 198, which may be configured to generate data for aggregation at the BS.

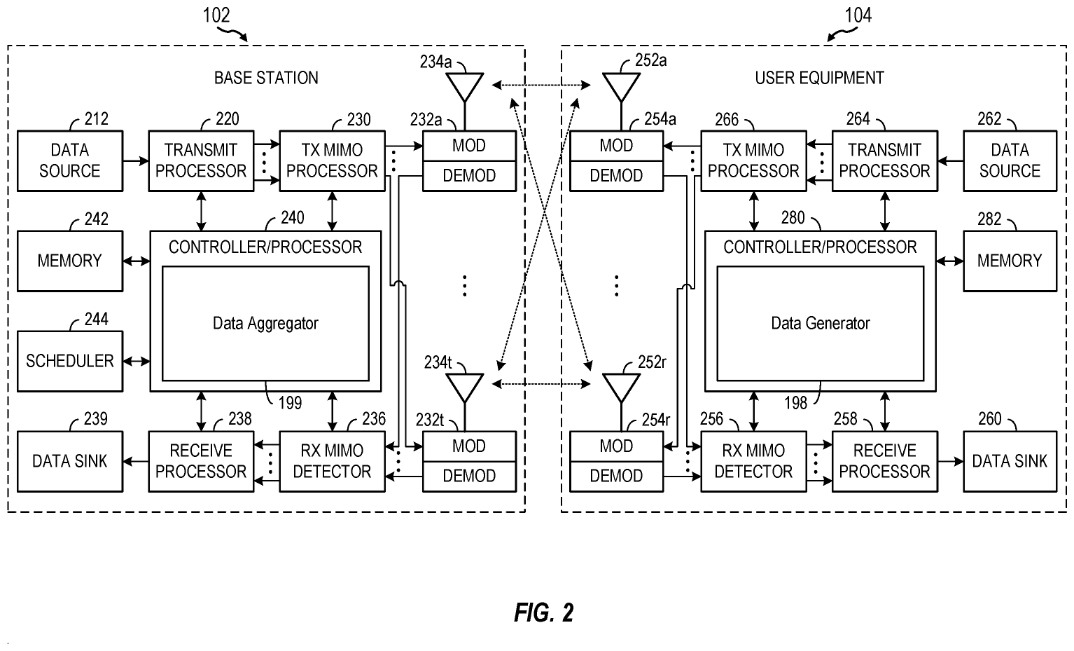

FIG. 2 depicts aspects of an example base station (BS) 102 and a user equipment (UE) 104.

Generally, base station 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes a data aggregator 199. Notably, while depicted as an aspect of controller/processor 240, the data aggregator 199 may be implemented additionally or alternatively in various other aspects of base station 102 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes a data generator 198. Notably, while depicted as an aspect of controller/processor 280, the data generator 198 may be implemented additionally or alternatively in various other aspects of user equipment 104 in other implementations.

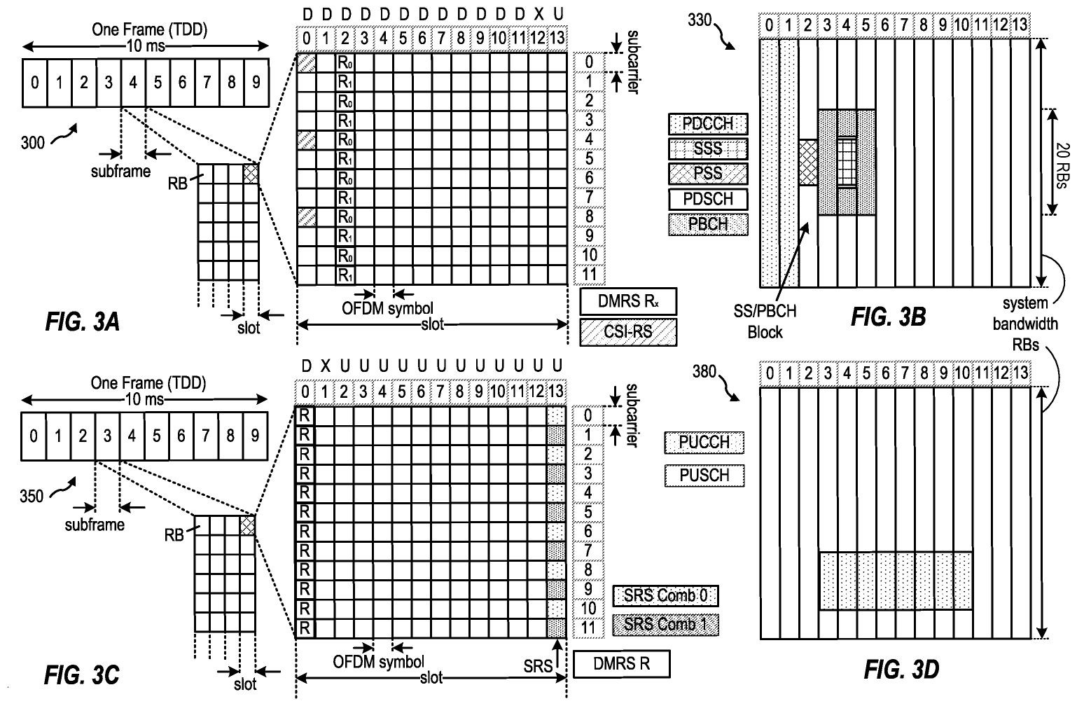

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5G networks may utilize several frequency ranges, which in some cases are defined by a standard, such as the 3GPP standards. For example, 3GPP technical standard TS 38.101 currently defines Frequency Range 1 (FR1) as including 600 MHz-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mmWave/near mmWave radio frequency band (e.g., 3 GHz-300 GHz) may have higher path loss and a shorter range compared to lower frequency communications. As described above with respect to FIG. 1, a base station (e.g., 180) configured to communicate using mmWave/near mmWave radio frequency bands may utilize beamforming (e.g., 182) with a UE (e.g., 104) to improve path loss and range. Aspects of the disclosure may be practiced in FR1 and/or FR2 frequency range.

### Example Federated Learning Model in a Wireless Network

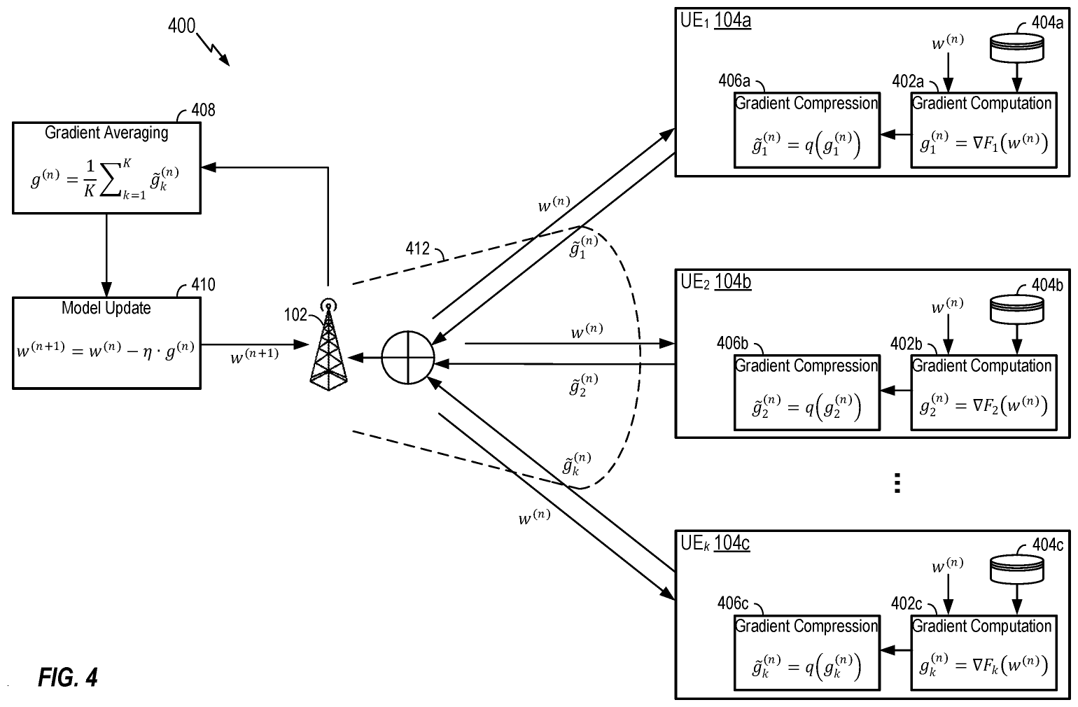

FIG. 4 is a schematic diagram illustrating an example of a federated learning architecture 400. In this example, the architecture 400 includes a base station (BS) 102 (e.g., BS 102 of FIG. 1) and a plurality of UEs (e.g., UEs 104 of FIG. 1) including a first UE 104a, a second UE 104b, and a third UE 104c (collectively referred to as “UEs 104”). It should be noted that more or fewer UEs may be supported.

Initially, the BS 102 may provide a statistical model (e.g., a “global model” that is shared between all of the nodes) to the plurality of UEs 104. Once the model is established, the BS 102 and UEs 104 may rely on an iterative process broken up into one or more UE-BS interactions known as “learning rounds,” (e.g., decentralized stochastic gradient descent (SGD) steps). Accordingly, the BS 102 may transmit model updates (e.g., w⁽ⁿ⁾, where n is an index of the round) to each of the UEs 104 during one or more rounds. For example, in a first round, the BS 102 may transmit initial parameters (e.g., w⁽⁰⁾, wherein an index for the first round is 0) of the model to the plurality of UEs.

For each round, each of the UEs 104 may receive the model update and perform training of the local model of each of the UEs 104 using the update. The training may include a local gradient computation 402 (e.g., performed based on a local data set 404 and the model update), and in some examples, a local gradient compression 406 (e.g., performed to compress the calculated local gradient). Accordingly, each of the UEs 104 may train the local model according to the model update and calculate one or more gradient vectors (e.g., g̅ₖ⁽ⁿ⁾, where n is an index of the round, and k identifies the UE to which the gradient vector corresponds) locally at each UE. Each gradient vector is a potential update to the global model. The UEs 104 may then transmit their locally calculated gradient vectors, or their compressed values, to the BS 102.

Upon receiving the gradient vectors from the UEs 104, the BS 102 may determine a gradient average (e.g., g⁽ⁿ⁾) of the gradient vectors by performing a gradient average calculation 408. The BS 102 may then generate a model update 410 (e.g., w⁽ⁿ⁺¹⁾) based on the gradient average, and transmit the model update to the plurality of UEs 104.

The foregoing steps may be repeated for each round until a global model requirement is met. In some examples, the global model requirement may include a minimum accuracy requirement (e.g., when an algorithm of the global model converges or a global loss function of the model is minimized). In some examples, the global loss function may be calculated using equations 1 and 2 below. For example, a local loss function may be calculated for each UE using equation 1, and the global loss function may be calculated using the result of the local loss function.

$${F}_{k} ( w ) = \frac{1}{\vert {D}_{k} \vert} {\sum }_{( {x}_{j} , {y}_{j} ) ∈ {D}_{k}} f ( w , {x}_{j} , {y}_{j} ) \qquad Equation 1$$

Wherein Fₖ(w) is the local loss function for a k^{th} UE of a plurality of UEs, Dₖ is a size of a local data set for the k^{th} UE, and Dₖ={xⱼ,yⱼ}, j∈{1, . . . , Tₖ}, where xⱼ is the jth input of the k^{th} UE, and Tₖ is the number of data points for the k^{th} UE, and yⱼ is the corresponding output vector.

$$F ( w ) = \frac{{\sum }_{k = 1}^{K} {\sum }_{j ∈ {D}_{k}} {f}_{j} ( w )}{K \cdot D} = \frac{1}{K} {\sum }_{k = 1}^{K} {F}_{k} ( w ) \qquad Equation 2$$

Wherein F(w) is the global loss function, and K is the number of UEs in the plurality of UEs. One example of a global model requirement is shown in equation 3 below. Here, w* is a minimum value of the global loss function.

$${w}^{*} = argmin F ( w ) \qquad Equation 3$$

### Efficient Communications for Updating a Federated Learning Model

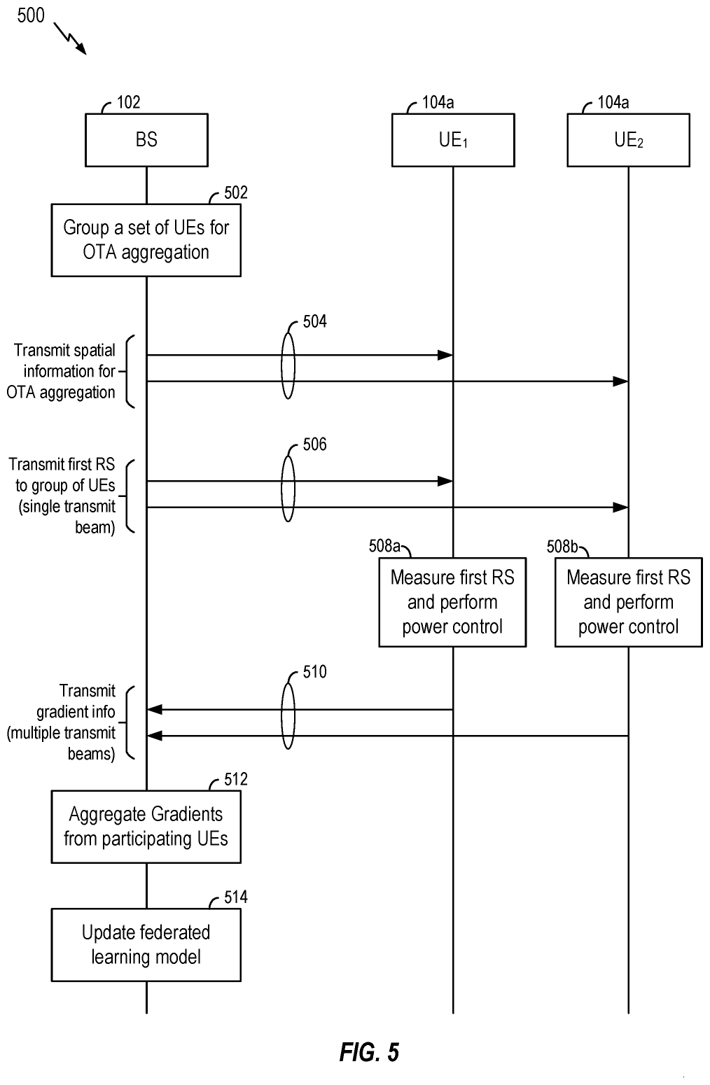

FIG. 5 is a call-flow diagram illustrating example communications 500 between a BS 102 (e.g., BS 102 of FIGS. 1 and 4) and both of a first UE 104a and a second UE 104b (e.g., first UE 104a and second UE 104b of FIG. 4). Although FIG. 5 illustrates two UEs, the techniques disclosed herein can support any suitable number of UEs.

Initially, the BS 102 may define, at a first process 502, a group of UEs including the first UE 104a and the second UE 104b (collectively referred to as “group of UEs 104”) to participate in over-the-air (OTA) aggregation of gradient vectors. The BS 102 may group the UEs according to any suitable criteria, including a position, location, and/or distance of each of the UEs relative to the BS 102. For example, the BS 102 may determine that each of the first UE 104a and the second UE 104b are relatively close to each other in a location where the BS 102 can transmit a directional beam that is receivable by both UEs. Of course, if other UEs are in the same location and serviced by the BS 102, then the BS 102 may include the other UEs in the group as well.

In a first communication 504, the BS 102 may transmit spatial relation information for OTA aggregation to each UE in the group of UEs 104 that indicates a spatial relation between a first reference signal (RS) to be transmitted by the BS 102 to the group of UEs 104 and an uplink transmission of gradient information by each of the UEs to the BS 102. The first RS may be a demodulation reference signal (DMRS), a channel state information reference signal (CSI-RS), or any other suitable RS. In certain aspects, the BS 102 may also transmit one or more second RSs over narrower beams than the first transmit beam, such as for use by one or more UEs 104 for channel estimation for a data channel, wherein each of the one or more second RSs are different from the first RS.

In some examples, in the same signaling as the spatial relation information or in different signaling, the BS 102 may transmit a group indicator to the UEs in the group of UEs 104. The group indicator may provide each of the UEs an indication that they are part of a particular group. For example, the first communication 504 may include a transmission of a group indicator to each of the first UE 104a and the second UE 104b. The group indicator may indicate that the first UE 104a and the second UE 104b are to transmit gradient information to the BS 102 during the same time window (e.g., a slot). In some examples, the group indicator includes an indication of time-frequency resources (e.g., a pattern, density, and/or periodicity of predefined signals occupying specific resource elements of a downlink transmission) used for communication of the first RS. In certain aspects, each UE in the group of UEs 104 may determine its group by mapping the specific time-frequency resources of the first RS indicated by the spatial relation information to a group index. The UEs may be preconfigured with the mapping by the BS 102 (e.g., as part of the spatial relation information), higher layers, or as part of a manufacturing process of the UEs.

In a second communication 506, the BS 102 may transmit, to the group of UEs 104, the first RS via the first transmit beam (e.g., first transmit beam 412 of FIG. 4). In certain aspects, the first transmit beam may be a wide beam relative to beams used for data transmission from the BS 102 to a UE 104. That is, relatively narrower beams may be used for individually transmitting (e.g., unicasting) data and the second RS from the BS 102 to a UE 104, while the relatively wider first transmit beam may be used by the BS 102 for transmitting (e.g., broadcasting/multicasting) the first RS to all the UEs in the group of UEs 104. In certain aspects, the first communication 504 and the second communication 506 are the same communication, meaning the spatial relation information may be transmitted with the first RS.

In response to receiving the first RS, each of the UEs in the group of UEs 104 may prepare to transmit gradient information (e.g., a gradient vector or a compressed gradient value calculated locally at each of the UEs) in a second process 508. Here, each UE of the group of UEs 104 may individually perform the second process (e.g., the first UE 104a may perform the second process 508a, and the second UE 104b may perform the second process 508b, each using locally collected data of the statistical model). During preparation to transmit the vector, each of the UEs may determine an uplink beam over which to transmit the gradient information, and determine a power level at which to transmit the gradient information.

In certain aspects, each of the UEs in the group of UEs 104 may, based on the spatial relation indication of the first RS, apply Tx spatial filtering configuration for the transmission of the gradient information that is based on the Rx spatial filtering configuration (e.g., is the same as, substantially same as, etc.) the UE used to receive the first RS. Such Tx spatial filtering configuration may correspond to an uplink beam.

Each UE of the group of UEs may also perform a power control procedure to determine an uplink transmit power to use when transmitting the gradient information. Here, because each of the UEs in the group of UEs 104 will be transmitting the gradient information to the BS 102 during the same time window, the power control procedure serves the purpose of controlling uplink transmission power so that the transmissions from the group of UEs 104 are received at a similar power level at the BS 102, thereby having the same relative weight when aggregated, such that one signal does not dominate another in the aggregated signal. In some examples, the power control procedure may include one or more of an open-loop or a closed-loop power control procedure. For open-loop power control, each UE may estimate an uplink path loss based on measurements of the first RS, and set the uplink transmit power accordingly.

At a third communication 510, the group of UEs 104 may transmit a set of signals within a same time window, wherein each signal of the set of signals includes gradient information of a given UE. The transmission of the set of signals to the BS 102 may be in response to the first RS of the second communication 506. The gradient information may include a locally calculated gradient vector, or its compressed value, as calculated by a corresponding UE (e.g., the UE that calculated a particular instance of gradient information). Each UE may individually transmit its gradient information using a transmit beam and a transmit power determined by each UE in the second process 508. The BS 102 receives the set of signals using a receive beam, such as, in certain aspects, a receive beam that has a similar configuration (e.g., shape, direction, etc.) as the transmit beam used to transmit the first RS. For example the receive beam of the BS 102 used to receive the set of signals may have a QCL relationship with the transmit beam used by the BS 102 to transmit the first RS.

In certain aspects, a UE (e.g., first UE 104a) of the group of UEs 104 may determine, during the second process, that it is unable to transmit gradient information to the BS 102 during the time window for a particular learning round. For example, during the power control procedure, the first UE 104a may determine that its uplink transmit power would be higher than a threshold value (e.g., higher than a regulatory limit, such as a maximum permissible exposure (MPE) for a particular frequency range, or would cause interference with uplink transmissions from other UEs in the group during the time window). In such a case, the first UE 104a may indicate to the BS 102 whether the first UE 104a is transmitting local gradient information. In this example, the first UE 104a may transmit an indication that it will refrain from transmitting the local gradient information for the particular learning round. Such a transmission will give the BS 102 information necessary for accurately performing the gradient average calculation 408, as the BS 102 will know, of the total number of UEs in the group of UEs 104, it is receiving gradient information from less than all of the total number.

At a third process 512, the BS 102 may, in response to receiving the set of signals from the group of UEs 104, aggregate the set of signals in the analog domain. In certain aspects, the BS 102 performs the gradient average calculation 408 by aggregating the set of signals in the analog domain. By aggregating in the analog domain, the BS 102 is able to reduce the set of analog signals into a single aggregated analog signal for analog-to-digital processing. This reduces processing overhead by eliminating analog-to-digital conversion of each signal in the set of signals.

At a fourth process 514, the BS 102 may update the federated learning model (e.g., generate a model update 410 of FIG. 4) based on an average of the gradient information determined from the aggregated set of signals received from the group of UEs 104.

Although FIGS. 4 and 5 illustrate examples of communication between a BS 102 and a single group of UEs 104, it should be noted that the BS 102 may select multiple sets of a plurality of UEs to form multiple groups of UEs for OTA gradient aggregation. In some examples, the BS 102 may perform the same corresponding BS functions described above but with multiple groups of UEs, and each of the multiple groups of UEs may perform the same corresponding UE functions as described above.

For example, the BS 102 may form two groups of UEs, wherein a first group of UEs are in a first location relative to the BS 102, and the second group of UEs are in a second location relative to the BS 102. The first location and the second location may be different locations, such that the wide transmit beam discussed above may not be capable of reaching both the first location and the second location. In this example, the BS 102 may transmit, to the second group of UEs, a second RS via a second transmit beam of the BS 102, wherein the second group of UEs share the same global federated learning model as the first group of UEs.

Upon receiving the second RS, the second group of UEs may transmit a second set of signals, wherein each signal carries local gradient information calculated by a corresponding UE of the second group of UEs. The BS 102 may then receive the second set of signals and aggregate, in the analog domain and separate from the first set of signals (e.g., the third communication 510 from the first group of UEs), the second set of signals to aggregate the second set of local gradient information. In certain aspects, the BS 102 receives the second set of signals using a second receive beam that has a similar configuration (e.g., shape, direction, etc.) as the second transmit beam used to transmit the second RS. For example the second receive beam of the BS 102 used to receive the second set of signals may have a QCL relationship with the second transmit beam used by the BS 102 to transmit the second RS. Because the gradient information from the first group of UEs and the second group of UEs is information corresponding to the same federated learning model, the first group and the second group of UEs may transmit the gradient information during the same time window. As such, the BS 102 may receive the gradient information from the two groups of UEs at the same time, and may aggregate the first set of signals with the second set of signals to determine the gradient average. For example, the BS 102 may separately aggregate the first set of signals in the analog domain and the second set of signals in the analog domain, and then separately perform analog to digital conversion of the aggregated first set of signals and the aggregated second set of signals. The BS 102 may aggregate the aggregated first set of signals and the aggregated second set of signals in the digital domain.

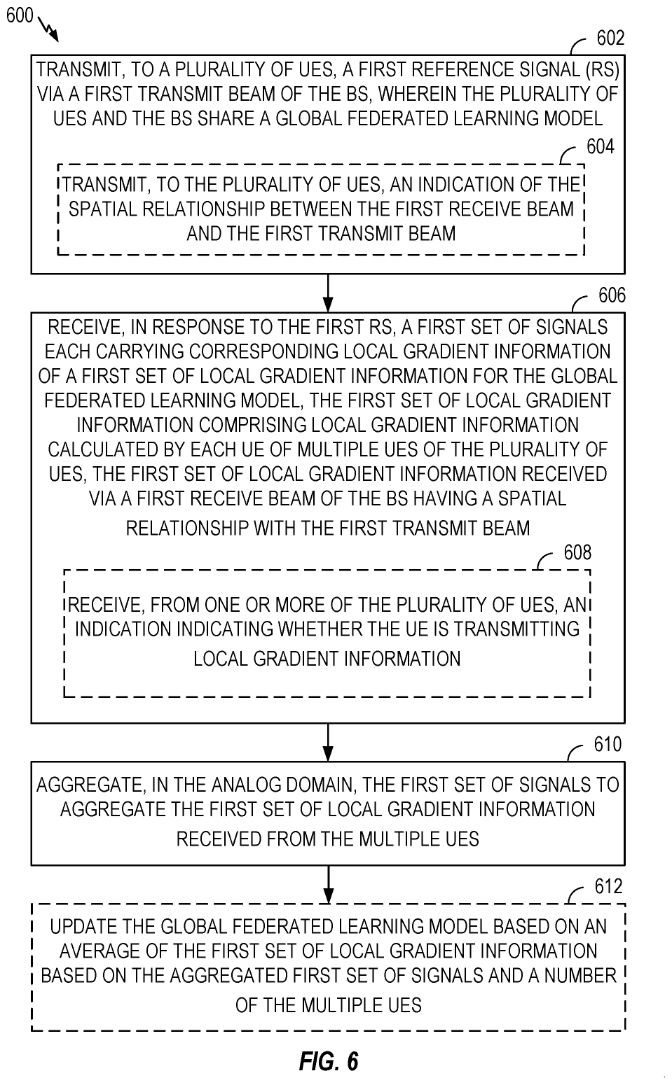

FIG. 6 is a flow diagram illustrating example operations 600 for wireless communication, in accordance with certain aspects of the present disclosure. The operations 600 may be performed, for example, by a BS (e.g., such as the BS 102 in the wireless communication network 100 of FIG. 1). The operations 600 may be complementary to the operations 700 performed by the UE. The operations 600 may be implemented as software components that are executed and run on one or more processors (e.g., controller/processor 240 of FIG. 2). Further, the transmission and reception of signals by the BS in operations 600 may be enabled, for example, by one or more antennas (e.g., antennas 234 of FIG. 2). In certain aspects, the transmission and/or reception of signals by the BS may be implemented via a bus interface of one or more processors (e.g., controller/processor 240) obtaining and/or outputting signals.

In certain aspects, the operations 600 may begin, at a first block 602, transmitting, to a plurality of UEs, a first reference signal (RS) via a first transmit beam of the BS, wherein the plurality of UEs and the BS share a global federated learning model.

In certain aspects, the operations 600 may optionally include a second block 604, for transmitting, to the plurality of UEs, an indication of a spatial relation of the first RS to transmission of local gradient information by UEs.

The operations 600 may include a third block 606 for receiving, in response to the first RS, a first set of signals each carrying corresponding local gradient information of a first set of local gradient information for the global federated learning model, the first set of local gradient information comprising local gradient information calculated by each UE of multiple UEs of the plurality of UEs, the first set of local gradient information received via a first receive beam of the BS.

In certain aspects, the operations 600 may optionally include a fourth block 608, for receiving, from one or more of the plurality of UEs, an indication indicating whether the UE is transmitting local gradient information.

The operations 600 may include a fifth block 610 for aggregating, in the analog domain, the first set of signals to aggregate the first set of local gradient information received from the multiple UEs.

In certain aspects, the operations 600 may optionally include a sixth block 612 for updating the global federated learning model based on an average of the first set of signals.

In certain aspects, local gradient information comprises a gradient vector corresponding to a given UE of the multiple UEs.

In certain aspects, the operations 600 include transmitting to the plurality of UEs a group indicator indicating to the plurality of UEs to transmit local gradient information during a same time window.

In certain aspects, the operations 600 include selecting the plurality of UEs based at least in part on a location of each UE of the plurality of UEs relative to the BS.

In certain aspects, the operations 600 include transmitting, to a first UE of the multiple UEs, a second RS via a second transmit beam of the BS, wherein the second transmit beam is narrower than the first transmit beam.

In certain aspects, the operations 600 are configured to support multiple groups of UEs. For example, the operations 600 may include transmitting, to a second plurality of UEs, a second reference signal (RS) via a second transmit beam of the BS, wherein the second plurality of UEs further share the global federated learning model; receiving, in response to the second RS, a second set of signals each carrying corresponding local gradient information of a second set of local gradient information for the global federated learning model, the second set of local gradient information comprising local gradient information calculated by second multiple UEs of the second plurality of UEs, the second set of local gradient information received via a second receive beam of the BS; and aggregating, in the analog domain and separate from the first set of signals, the second set of signals to aggregate the second set of local gradient information.

In certain aspects, the operations 600 may include receiving both the first set of local gradient information and the second set of local gradient information during a same time window.

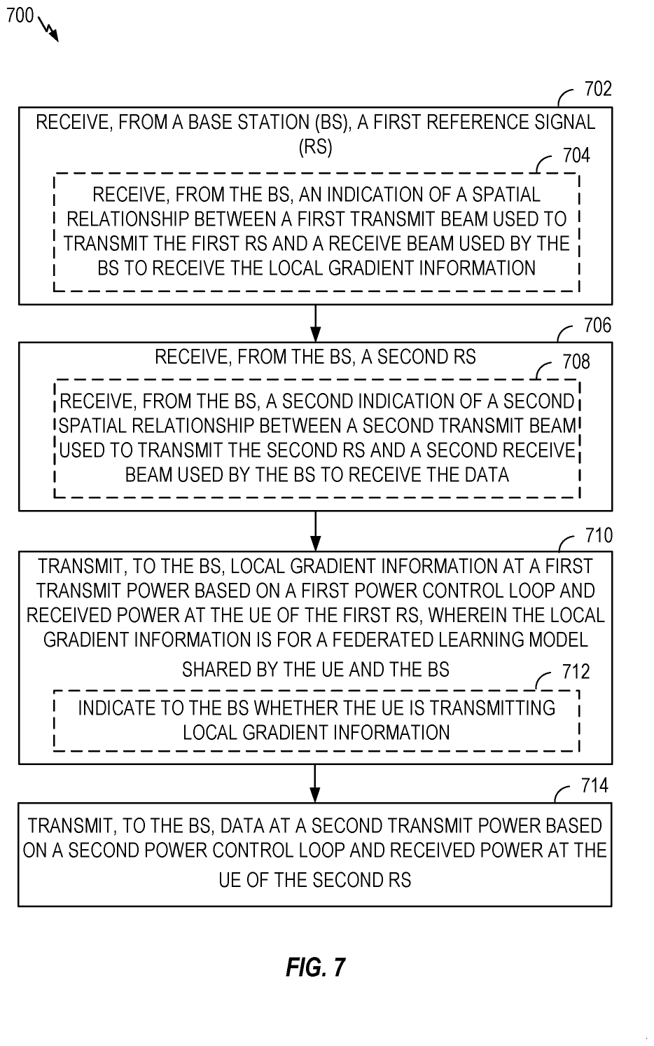

FIG. 7 is a flow diagram illustrating example operations 700 for wireless communication, in accordance with certain aspects of the present disclosure. The operations 700 may be performed, for example, by a UE (e.g., such as the UE 104 in the wireless communication network 100 of FIG. 1). The operations 700 may be complementary to the operations 600 performed by the BS. The operations 700 may be implemented as software components that are executed and run on one or more processors (e.g., controller/processor 280 of FIG. 2). Further, the transmission and reception of signals by the UE in operations 700 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 700 may begin, at a first block 702, by receiving, from a base station (BS), a first reference signal (RS).

In certain aspects, the operations 700 may optionally include a second block 704 for receiving, from the BS, an indication of a spatial relation of the first RS to transmission of local gradient information.

The operations 700 may include a third block 706 for receiving, from the BS, a second RS.

The operations 700 may include a fourth block 710 for transmitting, to the BS, local gradient information at a first transmit power based on both a first power control loop and received power of the first RS at the UE, wherein the local gradient information is for a federated learning model shared by the UE and the BS.

In certain aspects, the operations 700 may optionally include a fifth block 712 for indicating to the BS whether the UE is transmitting local gradient information.

The operations 700 may include a sixth block 714 for transmitting, to the BS, data at a second transmit power based on both a second power control loop and received power of the second RS at the UE.

### Example Wireless Communication Devices

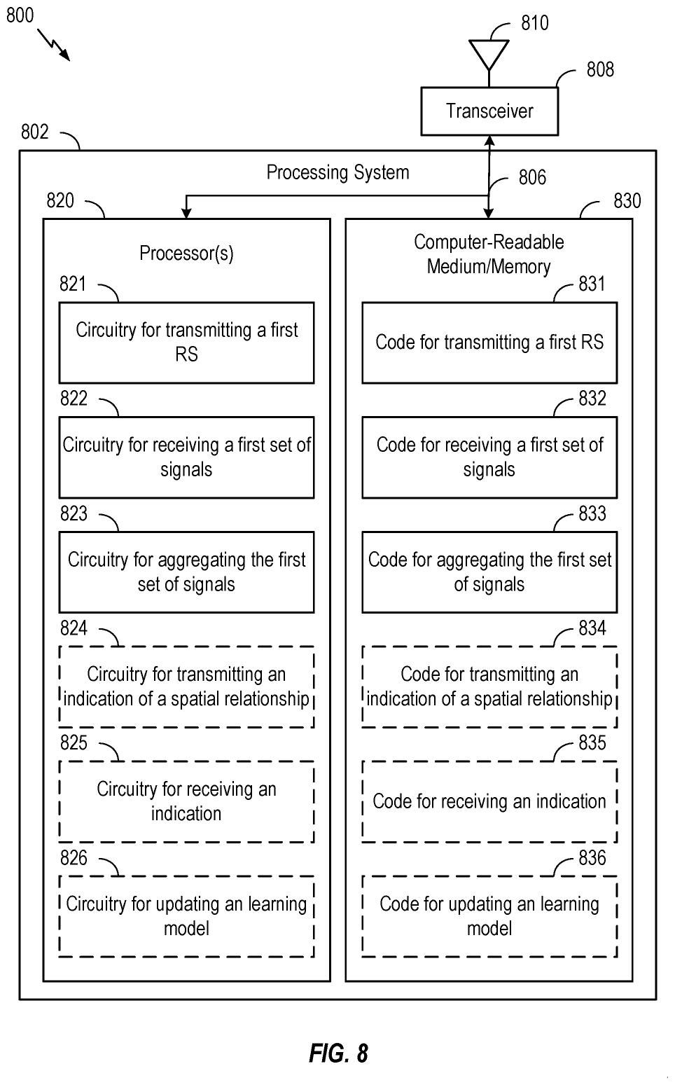

FIG. 8 depicts an example communications device 800 that includes various components operable, configured, or adapted to perform operations for the techniques disclosed herein, such as the operations depicted and described with respect to FIGS. 4-6. In some examples, communication device 800 may be a base station 102 as described, for example with respect to FIGS. 1 and 2.

Communications device 800 includes a processing system 802 coupled to a transceiver 808 (e.g., a transmitter and/or a receiver). Transceiver 808 is configured to transmit (or send) and receive signals for the communications device 800 via an antenna 810, such as the various signals as described herein. Processing system 802 may be configured to perform processing functions for communications device 800, including processing signals received and/or to be transmitted by communications device 800.

Processing system 802 includes one or more processors 820 coupled to a computer-readable medium/memory 830 via a bus 806. In certain aspects, computer-readable medium/memory 830 is configured to store instructions (e.g., computer-executable code) that when executed by the one or more processors 820, cause the one or more processors 820 to perform the operations illustrated in FIGS. 4-6, or other operations for performing the various techniques discussed herein for efficient over-the-air (OTA) aggregation of gradient data.

In the depicted example, computer-readable medium/memory 830 stores code 831 for transmitting, to a plurality of UEs, a first reference signal (RS) via a first transmit beam of the BS, wherein the plurality of UEs and the BS share a global federated learning model.

The computer-readable medium/memory 830 also stores code 832 for receiving, in response to the first RS, a first set of signals each carrying corresponding local gradient information of a first set of local gradient information for the global federated learning model, the first set of local gradient information comprising local gradient information calculated by each UE of multiple UEs of the plurality of UEs, the first set of local gradient information received via a first receive beam of the BS.

The computer-readable medium/memory 830 also stores code 833 for aggregating, in the analog domain, the first set of signals to aggregate the first set of local gradient information received from the multiple UEs.

Optionally, the computer-readable medium/memory 830 may store code 834 for transmitting, to the plurality of UEs, an indication of a spatial relation of the first RS to transmission of the local gradient information.

Optionally, the computer-readable medium/memory 830 may store code 835 for receiving, from one or more of the plurality of UEs, an indication indicating whether the UE is transmitting local gradient information.

Optionally, the computer-readable medium/memory 830 may store code 836 for updating the global federated learning model based on an average of the first set of signals.

In the depicted example, the one or more processors 820 include circuitry configured to implement the code stored in the computer-readable medium/memory 830, including circuitry 821 for transmitting, to a plurality of UEs, a first reference signal (RS) via a first transmit beam of the BS, wherein the plurality of UEs and the BS share a global federated learning model.

The one or more processors 820 may also include circuitry 822 for receiving, in response to the first RS, a first set of signals each carrying corresponding local gradient information of a first set of local gradient information for the global federated learning model, the first set of local gradient information comprising local gradient information calculated by each UE of multiple UEs of the plurality of UEs, the first set of local gradient information received via a first receive beam of the BS.

The one or more processors 820 may also include circuitry 823 for aggregating, in the analog domain, the first set of signals to aggregate the first set of local gradient information received from the multiple UEs.

Optionally, the one or more processors 820 may also include circuitry 824 for transmitting, to the plurality of UEs, an indication of a spatial relation of the first RS to transmission of the local gradient information.

Optionally, the one or more processors 820 may also include circuitry 825 for receiving, from one or more of the plurality of UEs, an indication indicating whether the UE is transmitting local gradient information.

Optionally, one or more processors 820 may also include circuitry 826 for updating the global federated learning model based on an average of the first set of signals.

Various components of communications device 800 may provide means for performing the methods and techniques described herein, including the methods and techniques illustrated in FIGS. 4-6.

In some examples, means for transmitting or sending (or means for outputting for transmission) may include the transceivers 232 and/or antenna(s) 234 of the base station 102 illustrated in FIG. 2 and/or transceiver 808 and antenna 810 of the communication device 800 in FIG. 8.

In some examples, means for receiving (or means for obtaining) may include the transceivers 232 and/or antenna(s) 234 of the base station illustrated in FIG. 2 and/or transceiver 808 and antenna 810 of the communication device 800 in FIG. 8.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for aggregating, updating, calculating, computing, determining, and indicating may include various processing system components, such as: the one or more processors 820 in FIG. 8, or aspects of the base station 102 depicted in FIG. 2, including receive processor 238, transmit processor 220, TX MIMO processor 230, and/or controller/processor 240 (including data aggregator 199).

Notably, FIG. 8 is an example, and many other examples and configurations of communication device 800 are possible.

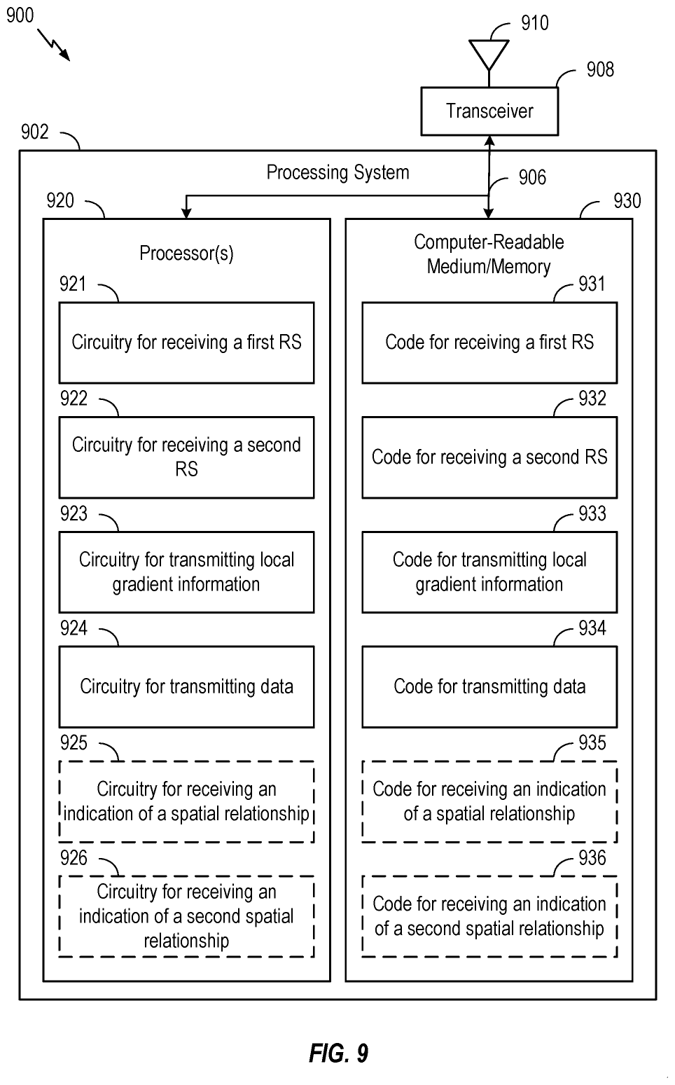

FIG. 9 depicts an example communications device 900 that includes various components operable, configured, or adapted to perform operations for the techniques disclosed herein, such as the operations depicted and described with respect to FIGS. 4, 5, and 7. In some examples, communication device 900 may be a user equipment 104 as described, for example with respect to FIGS. 1 and 2.

Communications device 900 includes a processing system 902 coupled to a transceiver 908 (e.g., a transmitter and/or a receiver). Transceiver 908 is configured to transmit (or send) and receive signals for the communications device 900 via an antenna 910, such as the various signals as described herein. Processing system 902 may be configured to perform processing functions for communications device 900, including processing signals received and/or to be transmitted by communications device 900.

Processing system 902 includes one or more processors 920 coupled to a computer-readable medium/memory 930 via a bus 906. In certain aspects, computer-readable medium/memory 930 is configured to store instructions (e.g., computer-executable code) that when executed by the one or more processors 920, cause the one or more processors 920 to perform the operations illustrated in FIGS. 4, 5, and 7, or other operations for performing the various techniques discussed herein for efficient over-the-air (OTA) aggregation of data.

In the depicted example, computer-readable medium/memory 930 stores code 931 for receiving, from a base station (BS), a first reference signal (RS).

The computer-readable medium/memory 930 also stores code 932 for receiving, from the BS, a second RS.

The computer-readable medium/memory 930 also stores code 933 for transmitting, to the BS, local gradient information at a first transmit power based on both a first power control loop and received power of the first RS at the UE, wherein the local gradient information is for a federated learning model shared by the UE and the BS.

The computer-readable medium/memory 930 also stores code 934 for transmitting, to the BS, data at a second transmit power based on both a second power control loop and received power of the second RS at the UE.

Optionally, the computer-readable medium/memory 930 also stores code 935 for receiving, from the BS, an indication of a spatial relation of the first RS to transmission of the local gradient information.

In the depicted example, the one or more processors 920 include circuitry configured to implement the code stored in the computer-readable medium/memory 930, including circuitry 921 for receiving, from a base station (BS), a first reference signal (RS).

The one or more processors 920 may also include circuitry 922 for receiving, from the BS, a second RS.

The one or more processors 920 may also include circuitry 923 for transmitting, to the BS, local gradient information at a first transmit power based on both a first power control loop and received power of the first RS at the UE, wherein the local gradient information is for a federated learning model shared by the UE and the BS.

The one or more processors 920 may also include circuitry 924 for transmitting, to the BS, data at a second transmit power based on both a second power control loop and received power of the second RS at the UE.

Optionally, the one or more processors 920 may also include circuitry 925 for receiving, from the BS, an indication of a spatial relation of the first RS to transmission of the local gradient information.

Various components of communications device 900 may provide means for performing the methods described herein, including with respect to FIGS. 4, 5, and 7.

In some examples, means for transmitting or sending (or means for outputting for transmission) may include the transceivers 254 and/or antenna(s) 252 of the user equipment 104 illustrated in FIG. 2 and/or transceiver 908 and antenna 910 of the communication device 900 in FIG. 9.

In some examples, means for receiving (or means for obtaining) may include the transceivers 254 and/or antenna(s) 252 of the user equipment 104 illustrated in FIG. 2 and/or transceiver 908 and antenna 910 of the communication device 900 in FIG. 9.

In some examples, means for aggregating, updating, calculating, computing, determining, and indicating may include various processing system components, such as: the one or more processors 920 in FIG. 9, or aspects of the user equipment 104 depicted in FIG. 2, including receive processor 258, transmit processor 264, TX MIMO processor 266, and/or controller/processor 280 (including data generator 198).

Notably, FIG. 9 is an example, and many other examples and configurations of communication device 900 are possible.

### Example Clauses

Implementation examples are described in the following numbered clauses:

Clause 1. A method for wireless communication by a base station (BS), comprising: transmitting, to a plurality of UEs, a first reference signal (RS) via a first transmit beam of the BS, wherein the plurality of UEs and the BS share a global federated learning model; receiving, in response to the first RS, a first set of signals each carrying corresponding local gradient information of a first set of local gradient information for the global federated learning model, the first set of local gradient information comprising local gradient information calculated by each UE of multiple UEs of the plurality of UEs, the first set of local gradient information received via a first receive beam of the BS; and aggregating, in an analog domain, the first set of signals to aggregate the first set of local gradient information received from the multiple UEs.

Clause 2. The method of Clause 1, further comprising: updating the global federated learning model based on an average of the first set of signals.

Clause 3. The method of Clause 2, further comprising: receiving, from one or more of the plurality of UEs, an indication indicating whether the UE is transmitting local gradient information.

Clause 4. The method of Clause 1, wherein the local gradient information comprises a gradient vector corresponding to the UE.

Clause 5. The method of Clause 1, further comprising: transmitting, to the plurality of UEs, an indication of a spatial relation of the first RS to transmission of the local gradient information.

Clause 6. The method of Clause 1, further comprising: transmitting, to the plurality of UEs, a group indicator indicating to each of the plurality of UEs to transmit the local gradient information during a same time window.

Clause 7. The method of Clause 6, further comprising: selecting the plurality of UEs based at least in part on a location of each UE of the plurality of UEs relative to the BS.

Clause 8. The method of Clause 1, further comprising: transmitting, to a first UE of the multiple UEs, a second RS via a second transmit beam of the BS, wherein the second transmit beam is narrower than the first transmit beam.

Clause 9. The method of Clause 1, further comprising: transmitting, to a second plurality of UEs, a second reference signal (RS) via a second transmit beam of the BS, wherein the second plurality of UEs further share the global federated learning model; receiving, in response to the second RS, a second set of signals each carrying corresponding local gradient information of a second set of local gradient information for the global federated learning model, the second set of local gradient information comprising local gradient information calculated by second multiple UEs of the second plurality of UEs, the second set of local gradient information received via a second receive beam of the BS; and aggregating, in the analog domain and separate from the first set of signals, the second set of signals to aggregate the second set of local gradient information.

Clause 10. The method of Clause 9, further comprising: receiving both the first set of local gradient information and the second set of local gradient information during a same time window.

Clause 11. A method for wireless communication by user equipment (UE), comprising: receiving, from a base station (BS), a first reference signal (RS); receiving, from the BS, a second RS; transmitting, to the BS, local gradient information at a first transmit power based on both a first power control loop and received power of the first RS at the UE, wherein the local gradient information is for a federated learning model shared by the UE and the BS; and transmitting, to the BS, data at a second transmit power based on both a second power control loop and received power of the second RS at the UE.

Clause 12. The method of Clause 11, further comprising: receiving, from the BS, an indication of a spatial relation of the first RS to transmission of the local gradient information.

Clause 13. The method of Clause 11, further comprising: indicating to the BS whether the UE is transmitting the local gradient information.

Clause 14. A BS comprising a memory and a processor configured to perform the method of any one of Clauses 1-10.

Clause 15. A BS comprising various means configured to perform the method of any one of Clauses 1-10.

Clause 16. A non-transitory computer readable medium storing instructions, that when executed by a BS, cause the BS to perform the method of any one of Clauses 1-10.

Clause 17. A UE comprising a memory and a processor configured to perform the method of any one of Clauses 11-13.

Clause 18. A UE comprising various means configured to perform the method of any one of Clauses 11-13.

Clause 19. A non-transitory computer readable medium storing instructions, that when executed by a UE, cause the UE to perform the method of any one of Clauses 11-13.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mmWave frequencies, the gNB 180 may be referred to as an mmWave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (p) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2×15 kHz, where is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### ADDITIONAL CONSIDERATIONS

The preceding description provides examples of methods and techniques for efficient over-the-air (OTA) gradient aggregation in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communication by a base station (BS), comprising:
transmitting, to a plurality of UEs, a first reference signal (RS) via a first transmit beam of the BS, wherein the plurality of UEs and the BS share a global federated learning model;
receiving, in response to the first RS, a first set of signals each carrying corresponding local gradient information of a first set of local gradient information for the global federated learning model, the first set of local gradient information comprising local gradient information calculated by each UE of multiple UEs of the plurality of UEs, the first set of local gradient information received via a first receive beam of the BS; and
aggregating, in an analog domain, the first set of signals to aggregate the first set of local gradient information received from the multiple UEs.

2. The method of claim 1, further comprising: updating the global federated learning model based on an average of the first set of signals.

3. The method of claim 2, further comprising: receiving, from one or more of the plurality of UEs, an indication indicating whether the UE is transmitting local gradient information.

4. The method of claim 1, wherein the local gradient information comprises a gradient vector corresponding to the UE.

5. The method of claim 1, further comprising: transmitting, to the plurality of UEs, an indication of a spatial relation of the first RS to transmission of the local gradient information.

6. The method of claim 1, further comprising: transmitting, to the plurality of UEs, a group indicator indicating to each of the plurality of UEs to transmit the local gradient information during a same time window.

7. The method of claim 6, further comprising: selecting the plurality of UEs based at least in part on a location of each UE of the plurality of UEs relative to the BS.

8. The method of claim 1, further comprising: transmitting, to a first UE of the multiple UEs, a second RS via a second transmit beam of the BS, wherein the second transmit beam is narrower than the first transmit beam.

9. The method of claim 1, further comprising:
transmitting, to a second plurality of UEs, a second reference signal (RS) via a second transmit beam of the BS, wherein the second plurality of UEs further share the global federated learning model;
receiving, in response to the second RS, a second set of signals each carrying corresponding local gradient information of a second set of local gradient information for the global federated learning model, the second set of local gradient information comprising local gradient information calculated by second multiple UEs of the second plurality of UEs, the second set of local gradient information received via a second receive beam of the BS; and
aggregating, in the analog domain and separate from the first set of signals, the second set of signals to aggregate the second set of local gradient information.

10. The method of claim 9, further comprising: receiving both the first set of local gradient information and the second set of local gradient information during a same time window.

11. A method for wireless communication by user equipment (UE), comprising:
receiving, from a base station (BS), a first reference signal (RS);
receiving, from the BS, a second RS;
transmitting, to the BS, local gradient information at a first transmit power based on both a first power control loop and received power of the first RS at the UE, wherein the local gradient information is for a federated learning model shared by the UE and the BS; and
transmitting, to the BS, data at a second transmit power based on both a second power control loop and received power of the second RS at the UE.

12. The method of claim 11, further comprising: receiving, from the BS, an indication of a spatial relation of the first RS to transmission of the local gradient information.

13. The method of claim 11, further comprising: indicating to the BS whether the UE is transmitting the local gradient information.

14. A base station (BS) configured for wireless communication, comprising:
a memory; and
a processor coupled to the memory, the processor and the memory configured to cause the BS to:
transmit, to a plurality of UEs, a first reference signal (RS) via a first transmit beam of the BS, wherein the plurality of UEs and the BS share a global federated learning model;
receive, in response to the first RS, a first set of signals each carrying corresponding local gradient information of a first set of local gradient information for the global federated learning model, the first set of local gradient information comprising local gradient information calculated by each UE of multiple UEs of the plurality of UEs, the first set of local gradient information received via a first receive beam of the BS; and
aggregate, in an analog domain, the first set of signals to aggregate the first set of local gradient information received from the multiple UEs.

15. The BS of claim 14, wherein the processor and the memory are further configured to cause the BS to: update the global federated learning model based on an average of the first set of signals.

16. The BS of claim 15, wherein the processor and the memory are further configured to cause the BS to: receive, from one or more of the plurality of UEs, an indication indicating whether the UE is transmitting local gradient information.

17. The BS of claim 14, wherein the local gradient information comprises a gradient vector corresponding to the UE.

18. The BS of claim 14, wherein the processor and the memory are further configured to cause the BS to: transmit, to the plurality of UEs, an indication of a spatial relation of the first RS to transmission of the local gradient information.

19. The BS of claim 14, wherein the processor and the memory are further configured to cause the BS to: transmit, to the plurality of UEs, a group indicator indicating to each of the plurality of UEs to transmit the local gradient information during a same time window.

20. The BS of claim 19, wherein the processor and the memory are further configured to cause the BS to: select the plurality of UEs based at least in part on a location of each UE of the plurality of UEs relative to the BS.

21. The BS of claim 14, wherein the processor and the memory are further configured to cause the BS to:
transmit, to a first UE of the multiple UEs, a second RS via a second transmit beam of the BS, wherein the second transmit beam is narrower than the first transmit beam.

22. The BS of claim 14, wherein the processor and the memory are further configured to cause the BS to:
transmit, to a second plurality of UEs, a second reference signal (RS) via a second transmit beam of the BS, wherein the second plurality of UEs further share the global federated learning model;
receive, in response to the second RS, a second set of signals each carrying corresponding local gradient information of a second set of local gradient information for the global federated learning model, the second set of local gradient information comprising local gradient information calculated by second multiple UEs of the second plurality of UEs, the second set of local gradient information received via a second receive beam of the BS; and
aggregate, in the analog domain and separate from the first set of signals, the second set of signals to aggregate the second set of local gradient information.

23. The BS of claim 22, wherein the processor and the memory are further configured to cause the BS to: receive both the first set of local gradient information and the second set of local gradient information during a same time window.

24. A user equipment (UE) configured for wireless communication, comprising:
a memory; and
a processor coupled to the memory, the processor and the memory configured to cause the UE to:
receive, from a base station (BS), a first reference signal (RS);
receive, from the BS, a second RS;
transmit, to the BS, local gradient information at a first transmit power based on both a first power control loop and received power of the first RS at the UE, wherein the local gradient information is for a federated learning model shared by the UE and the BS; and
transmit, to the BS, data at a second transmit power based on both a second power control loop and received power of the second RS at the UE.

25. The UE of claim 24, wherein the processor and the memory are further configured to cause the UE to: receive, from the BS, an indication of a spatial relation of the first RS to transmission of the local gradient information.

26. The UE of claim 24, wherein the processor and the memory are further configured to cause the UE to: indicate to the BS whether the UE is transmitting the local gradient information.
